(19) United States
(12) Patent Application Publication
(10) Pub. No.: US 2002/0094183 A1
(43) Pub. Date: Jul. 18, 2002

(54) Waveguide having efficient dimensions

(76) Inventors: Chi Wu, San Marino, CA (US); Wenhua Lin, Pasadena, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/778,285

(22) Filed: Feb. 7, 2001

Related U.S. Application Data
(63) Continuation-in-part of application No. 09/765,723, filed on Jan. 18, 2001.

(51) Int. Cl. G02B 6/122

(52) U.S. Cl. 385/129

(57) ABSTRACT

An optical component is disclosed. The optical component includes a base adjacent to a light transmitting medium. A waveguide is defined in the light transmitting medium. The waveguide has a thickness of greater than 5 μm measured from the base, and has no or very small polarization dependence. In some instances, the waveguide is a member of an array waveguide grating and is sized to have little or no polarization dependence.

### RELATED APPLICATIONS

This application is a continuation-in-part of U.S. patent application Ser. No. 09/765,723, filed on Jan. 18, 2001, entitled “Optical Attenuator” and incorporated herein in its entirety.

### BACKGROUND

1. Field of the Invention

The invention relates to one or more optical networking components. In particular, the invention relates to optical components having one or more waveguides.

2. Background of the Invention

Optical networks employ a variety of optical components such as switches, demultiplexers and attenuators. Each component typically includes one or more waveguides for carrying the light signals to be processed by the component. The waveguides are often coupled to an optical fiber in communication with an optical network.

The cross section of the waveguides on an optical component is often different than the cross section of the optical fibers. As a result, light signals traveling between the waveguides and optical fibers can often experience excitation of undesirable modes. One attempt to address this difficulty has been to fabricate a mode transformer between the waveguide and the optical fiber. However, these mode transformers are often associated with increased optical losses and manufacturing costs.

For the above reasons, there is a need for an optical component that is not associated with optical losses when coupled with an optical fiber.

### SUMMARY OF THE INVENTION

The invention relates to an optical component. The optical component includes a base adjacent to a light transmitting medium. A waveguide is defined in the light transmitting medium. The waveguide has a thickness of greater than 12 μm measured from the base. In some instances, the waveguide is a member of an array waveguide grating.

Another embodiment of the component includes an array waveguide grating formed in a light transmitting medium positioned adjacent to a base. The array waveguide grating includes a plurality of array waveguides. At least a portion of the array waveguides have a thickness of greater than 5 μm measured from the base.

In some instances, the width of the waveguide is greater than 30%, 40%, 50%, 70% or 90% of the thickness of the waveguide. In other instances, the width of the waveguide is between 30% and 100% of the waveguide thickness.

The invention also relates to a method of forming an optical component. The method includes obtaining a light transmitting medium positioned adjacent to a base. The method also includes forming a waveguide in the light transmitting medium such that the waveguide has a thickness of greater than 12 μm measured from the base.

Another embodiment of the method includes obtaining a light transmitting medium positioned adjacent to a base. The method also includes forming an array waveguide grating in the light transmitting medium. The array waveguide grating includes a plurality of array waveguides. At least a portion of the array waveguides have a thickness of greater than 5 μm measured from the base.

### BRIEF DESCRIPTION OF THE FIGURES

FIG. 1 illustrates an example of a component having a plurality of waveguides.

FIG. 2A is a perspective view of an optical component having a plurality of waveguides.

FIG. 2B is a cross sectional view of the component shown in FIG. 2A taken at any of the lines labeled A.

FIG. 2C is a cross sectional view of a component having a waveguide coupled to an optical fiber. The cross section is taken along the longitudinal axis of the waveguide and the optical fiber.

FIG. 2D is a sideview of the waveguide shown in FIG. 2C taken in the direction of the arrow labeled A. The dashed line illustrates the outline of the optical fiber.

FIG. 3A is a cross section of a waveguide positioned over a base having a continuous light barrier.

FIG. 3B is a cross section of a waveguide positioned over a base having drains positioned adjacent to the light barrier. The drains serve to drain light signals that escape the light signal carrying region from the waveguide.

FIG. 4A and FIG. 4B illustrate a method of forming an optical component according to the present invention.

### DETAILED DESCRIPTION OF THE PREFERRED EMBODIMENT

The invention relates to an optical component that includes a light transmitting medium positioned over a base. One or more waveguides are defined in the light transmitting medium. The waveguides have a thickness greater than 12 μm from the base. In some instances, the waveguides have a thickness greater than 12.5 μm, 13 μm, 13.5 μm, 14 μm, 14.5 μm 15 μm, 16 μm or 17 μm.

Prior waveguides have a thickness of about 4-5 μm while the core of most optical fibers is on the order of about 10 μm. Accordingly, many prior optical components require mode transformers at the interface of the waveguide and the optical fiber. Increasing the thickness of the waveguide to be greater than 12 μm places the dimensions of the waveguide on the order of the thickness of the optical fiber. As a result, the need for mode transformers is eliminated.

In one embodiment of the invention, the light transmitting medium includes waveguides arranged in an arrayed waveguide grating. At least a portion of the waveguides in the arrayed waveguide grating have a thickness of greater than 5 μm. In some instances, at least a portion of the waveguides in the arrayed waveguide grating have a thickness greater than 6 μm, 7 μm, 8 μm, 9 μm, 10 μm, 11 μm, 12 μm or, 14 μm.

A variety of optical components employ array waveguide gratings for processing of light signals. For instance, many demultiplexers include an array waveguide grating positioned between star couplers. The array waveguide grating creates a phase differential between light signals traveling through adjacent waveguides. These array waveguide arrays exhibit power destruction when there is a large difference between the index of refraction of light polarized in perpendicular directions. For instance, the amount of power destruction increases as the difference between the index of refraction of light polarized in the x direction, Eₓ, and the index of refraction of light polarized in the y direction, E_{y}, increases. Increasing the dimensions of the array waveguides reduces this difference and accordingly reduces the amount of power loss associated with the array waveguide grating. The dimensions of waveguides according to the present invention can be increased so as to reduce or eliminate polarization dependence.

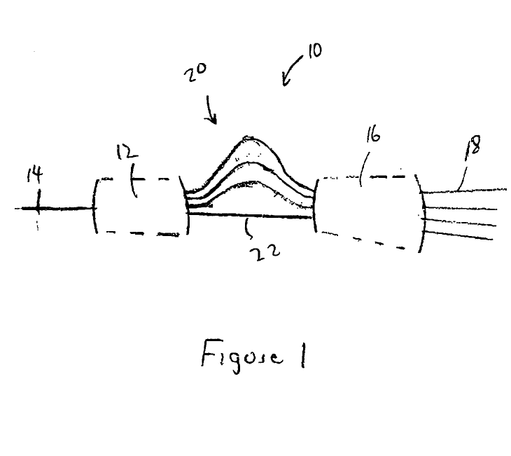

FIG. 1 illustrates an example of a component 10 that includes a plurality of waveguides. The illustrated component 10 is a demultiplexer, however, the component 10 can be operated in reverse as a multiplexer.

The component 10 includes a first light distribution component 12 in optical communication with a first waveguide 14 and a second light distribution component 16 in optical communication with a plurality of third waveguides 18. Although one first waveguide 14 is shown, the component 10 can include more than one first waveguide 14. A suitable light distribution component 10 can receive light at one area and distributes the light over a larger area and/or receive light from an area and focus the light on a smaller area. For instance, when the component 10 is operated as a demultiplexer, the first light distribution component 12 receives light at one area and distributes the light over a larger area while the second light distribution component 16 receives light at one area and focuses the light over a larger area. The first light distribution component 12 and the second light distribution component 16 serve the opposite functions when the component 10 is operated in reverse as a multiplexer.

A suitable light distribution component 10 includes, but is not limited to, a star coupler, a Rowland circle, multi-mode interference device, a mode expander, a slab waveguide, a lens and a lens assembly including two or more lenses.

Light can travel between the first light distribution component 12 and the second light distribution component 16 via an array waveguide grating 20. The array waveguide grating 20 includes an array of second waveguides 22. The length of each second waveguide 22 is different than the length of the adjacent waveguide(s) by a constant length differential, ΔL. In order for the second waveguides 22 to have different lengths and connect the first and second light distribution component 16, at least a portion of the second waveguides 22 have a curved shape.

During operation of the component 10, light signals from the first waveguide 14 enter the first light distribution component 12 that distributes the light signal to a plurality of the second waveguides 22. The light signals travel through the second waveguides 22 into the second light distribution component 16. Because the adjacent second waveguides 22 have different lengths, the light signal from each second waveguide 22 enters the second light distribution component 16 in a different phase. The phase differential causes the light signal to be focused at a particular one of the third waveguides 18. The third waveguide 18 on which the light signal is focused is a function of the wavelength of light of the light signal. Accordingly, light signals of different wavelengths are focused on different third waveguides 18. Accordingly, each third waveguide 18 carries a light signal of a different wavelength.

Although the array waveguide grating 20 illustrated in FIG. 1 is illustrated with four second waveguides 22, array waveguide gratings 20 typically have several tens to several hundreds of second waveguides 22. However, the number of second waveguides can be as low as two.

Although the array waveguide grating 20 illustrated in FIG. 1 includes curved waveguides, other array waveguide grating 20 constructions are possible. For instance, U.S. patent application Ser. No. (not yet assigned), filed on Nov. 28, 2000, entitled “A Compact Integrated Optics Based Arrayed Waveguide Demultiplexer” and incorporated herein in its entirety teaches a variety of array waveguide gratings 20 having second waveguides 22 constructed from straight branches.

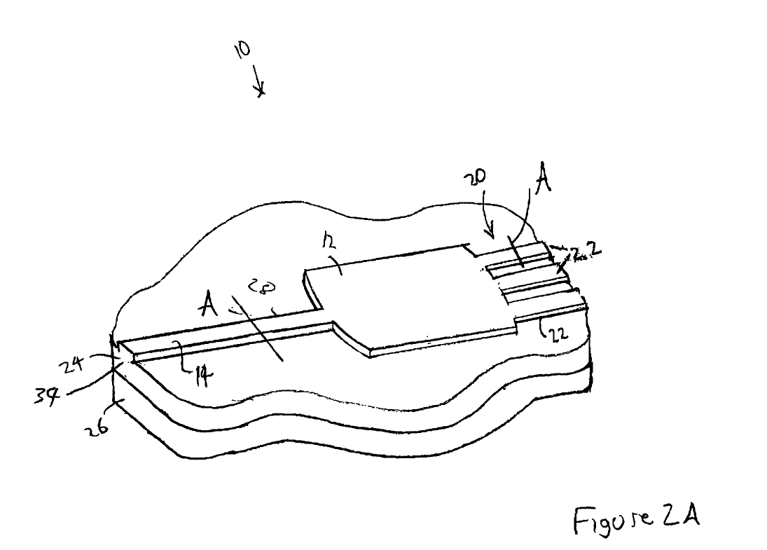

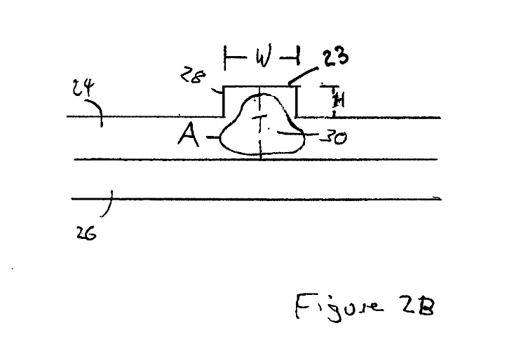

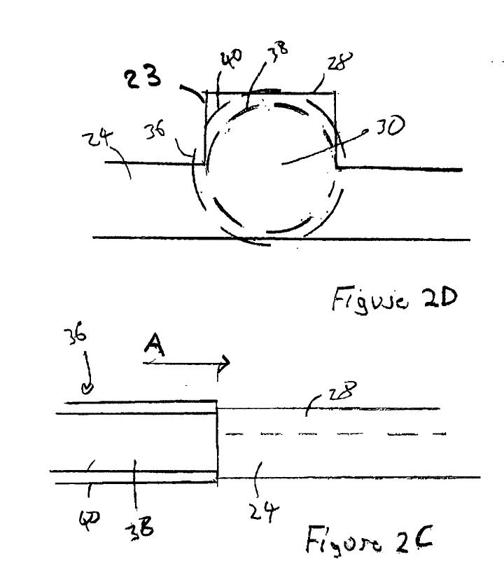

FIG. 2A and FIG. 2B illustrate construction of a portion of a component 10 configured to serve as a demultiplexer and/or a multiplexer. FIG. 2A is a perspective view of a portion of the optical component 10 and FIG. 2B is a cross section of the component 10 illustrated in FIG. 2A taken at any of the lines labeled A.

Accordingly, the cross section of the waveguide 23 illustrated in FIG. 2B can be a 25 cross section of a first waveguide 14, a second waveguide 22 or a third waveguide 18.

The component 10 includes a light transmitting medium 24 positioned adjacent to a base 26. A suitable light transmitting medium 24 includes, but is not limited to, silicon and silica. The light transmitting medium 24 includes a plurality of ridges 28. Each ridge 28 defines a portion of a light signal carrying region 30 of a waveguide. For instance, FIG. 2B illustrates the profile of a light signal traveling through the light signal carrying region 30. The portion of the base 26 under the ridge 28 includes a material that reflects light signals from the light signal carrying region 30 back into the light signal carrying region 30. As a result, the base 26 also defines a portion of the light signal carrying region 30.

The illustrated portion of the component 10 includes a first waveguide 14, first light distribution component 12 and a plurality of second waveguides 22. The first waveguide 14 includes a facet 34 through which light signals can enter and/or exit the component 10.

The thickness of the waveguide 23 is labeled as T in FIG. 2B. As shown the thickness of the waveguide 23 is measured from the base 26. The width of the base 26 is labeled W and the height of the ridge 28 is labeled H.

The first waveguides 14, the third waveguides 18 and/or the third waveguides 22 can have a thickness greater than 5 μm. In some instances, the waveguides 23 have a thickness greater than 6 μm, 7 μm, 8 μm, 9 μm, 10 μm, 11 μm, 12 μm, 12.5 μm, 13 μm, 13.5 μm, 14 μm, 14.5 μm, 15 μm or 16 μm. In other instances, the waveguide 23 thickness is between 12 and 16 μm or 12.5 and 15.5 μm. The first waveguide 14, the second waveguide 18 and/or the third waveguide 22 on a component 10 can have the same dimensions or different waveguides can have different dimensions.

The width of the waveguides 23 is generally less than the thickness of the waveguides while increasing with the thickness of the waveguide. In some instances, the width of the waveguide 23 is greater than 60% of the thickness of the waveguide 23, 70% of the thickness of the waveguide 23, 80% of the thickness of the waveguide 23 or 90% of the thickness of the waveguide 23. In other instances, the width of the waveguide 23 is between 60% and 100% of the waveguide thickness, 70% and 100% of the waveguide thickness, 80% and 100% of the waveguide thickness or 90% and 100% of the waveguide thickness. In still other instances, the width of the waveguide is between 3 to 15 μm, 5 to 15 μm, 7 to 14 μm or 9 to 12 m.

The height of the ridge 28 is generally about 30 to 70% of the waveguide thickness. In some instances, the height of the ridge 28 is 40 to 60% of the waveguide thickness. In other instances, the height of the ridge 28 is 2.5 to 12 μm or 3 to 10 μm.

FIG. 2C and FIG. 2D illustrate the position of the facet 34 relative to an optical fiber 36 when the optical fiber 36 is coupled with the facet 34. FIG. 2C is a cross sectional view of the light transmitting medium 24 taken along the longitudinal length of the waveguide 23. The base 26 of the ridge 28 is illustrated as a dashed line. FIG. 2D is a sideview of the component 10 taken in the direction of the line labeled A in FIG. 2C. The optical fiber 36 is illustrated as having a core 38 and a cladding 40. The outline of the core 38 and the cladding 40 are illustrated as dashed lines in FIG. 2D.

The core 38 of the optical fiber 36 is substantially centered relative to the facet 34 of the waveguide. The width of the waveguide 23 has substantially the same size as the diameter of the core 38. The waveguide extends beyond the core 38 above and below the core 38 because the thickness of the waveguide 23 is generally larger than the width of the waveguide 23. A mode transformer is not required because the dimensions of the waveguide 23 are on the order of the optical fiber 36 dimensions.

Although the waveguide 23 is illustrated as having a width that matches the diameter of the core 38, the waveguide 23 can have a width that is less than the diameter or greater than the diameter. Additionally, the thickness can be less than the core 38 diameter. In some instances, the thickness of the waveguide 23 is chosen to match the diameter of the core 38.

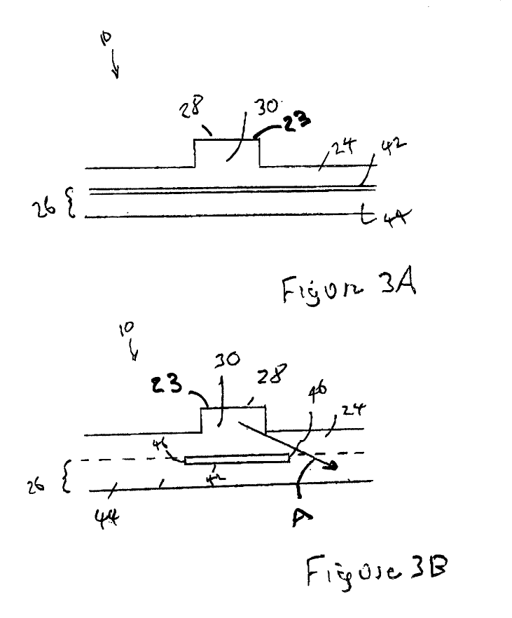

The base 26 can have a variety of constructions. FIG. 3A illustrates a component 10 having a base 26 with a light barrier 42 positioned over a substrate 44. The light barrier 42 serves to reflect the light signals from the light signal carrying region 30 back into the light signal carrying region 30.

The light barrier 42 can have reflective properties such as a metal. Alternatively, the light barrier 42 can have a lower index of refraction than the light transmitting medium 24. The drop in the index of refraction causes reflection of the light signals. For instance, the light barrier 42 can be silica when the light transmitting medium 24 is silicon. A suitable substrate 44 includes, but is not limited to, a silicon substrate 44.

The light barrier 42 need not extend over the entire substrate 44 as shown in FIG. 3B. For instance, the light barrier 42 can be an air filled pocket formed in the substrate 44. In some instances, the light transmitting medium 24 is also positioned adjacent to the sides 46 of the light barrier 42. As a result, light signals that exit the light signal carrying region 30 can be drained from the waveguide 23 as shown by the arrow labeled A. These light signals are less likely to enter adjacent waveguides 23. Accordingly, these light signals are not significant source of cross talk. The drain effect can be achieved by placing a second light transmitting medium adjacent to the sides 46 of the light barrier 42. The drain effect is best achieved when the second light transmitting medium has an index of refraction that is substantially equal to or greater than the index of refraction of the light transmitting medium 24 positioned over the base 26.

Other base 26 constructions can be used with the light transmitting medium 24. For instance, U.S. patent application Ser. No. (Not yet assigned), filed on Oct. 10, 2000, entitled “Waveguide Having a Light Drain” and U.S. patent application Ser. No. (Not yet assigned), filed on Nov. 28, 2000, entitled “Silica Waveguide” teach a variety of base 26 constructions that are suitable for use with the light transmitting medium 24.

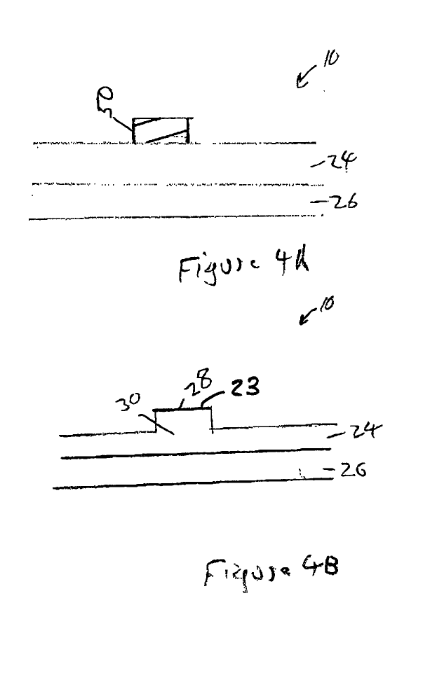

FIG. 4A and FIG. 4B illustrate a method of forming a component 10 having a waveguide 23 with the desired dimensions. An optical component 10 having a light transmitting medium 24 adjacent to a base 26 is obtained as shown in FIG. 4A. An example of a suitable optical component 10 includes a silicon on insulator wafer. The light transmitting medium 24 has the desired thickness of the waveguide 23. When the light transmitting medium 24 does not have the desired thickness of the waveguide 23, the light transmitting medium 24 can be polished or etched to the desired waveguide thickness. Alternatively, additional light transmitting medium 24 can be grown on the component 10 or bonded to the component 10. When the component 10 has the desired waveguide thickness, a mask 50 is formed over the regions of the component 10 where a ridge 28 is to be formed. The width of the mask 50 matches the desired width of the waveguide 23.

An etch is performed and the mask 50 removed to obtain the component 10 shown in FIG. 4B. The etch is performed to a depth that results in the ridge 28 having the desired height. The sides of the ridge 28 are preferably smooth in order to reduce scattering. As a result, a suitable etch includes, but is not limited to, a reactive ion etch, an etch according to the Bosch process or an etch in accordance with U.S. patent application entitled “Formation Of A Vertical Smooth Surface On An Optical Component 10 102”, Ser. No. ___,___, filed on Oct. 16, 2000 and incorporated herein in its entirety.

Although the method illustrated in FIG. 4A and FIG. 4B shows fabrication of a component 10 having a single waveguide 23, the method can be adapted to fabrication of components 10 having a plurality of waveguides 23 by forming the mask 50 over the regions of the component 10 where all the waveguides are to be formed. Additionally, the first light distribution component 12 and/or the second light distribution component 16 can be formed concurrently with the waveguide 23 by forming the mask 50 over the regions of the component 10 where the first light distribution component 12 and/or the second light distribution component 16 are to be formed.

Although the waveguides 23 according to the present invention are disclosed in the context of a demultiplexer, the waveguides 23 can be employed in conjunction with other optical components 10 including, but not limited to, switches, splitters, couplers, filters, tunable filters, modulators, gain equalizers, fibers dispersion compensators.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical component, comprising:
a base; and
a waveguide defined in a light transmitting medium positioned adjacent to the base, the waveguide having a thickness of greater than 12 μm measured from the base.

2. The component of claim 1, wherein the waveguide has a thickness greater than 12.5 μm.

3. The component of claim 1, wherein the waveguide has a thickness greater than 13 μm.

4. The component of claim 1, wherein the waveguide has a thickness greater than 14 μm.

5. The component of claim 1, wherein the waveguide has a thickness greater than 14.5 μm.

6. The component of claim 1, wherein the waveguide has a thickness greater than 15 μm.

7. The component of claim 1, wherein the waveguide has a thickness between 12 and 16 μm.

8. The component of claim 1, wherein the waveguide has a thickness between 12.5 and 15.5 μm.

9. The component of claim 1, wherein the waveguide includes a ridge with a width of between 30% and 100% of the waveguide thickness.

10. The component of claim 1, wherein the waveguide includes a ridge with a width of between 70% and 100% of the waveguide thickness.

11. The component of claim 1, wherein the waveguide includes a ridge with a height of 2.5 to 12 μm.

12. The component of claim 1, wherein the waveguide includes a ridge with a height of 3 to 10 μm.

13. The component of claim 1, wherein the waveguide is a member of an array waveguide grating.

14. An optical component, comprising:
a base; and
a light transmitting medium positioned adjacent to the base, the light transmitting medium including an array waveguide grating including a plurality of array waveguides, at least a portion of the array waveguides having a thickness of greater than 5 μm measured from the base.

15. The component of claim 14, wherein the array waveguide grating provides optical communication between a first light distribution component and a second light distribution component.

16. The component of claim 14, wherein at least a portion of the array waveguides have a thickness greater than 6 μm.

17. The component of claim 14, wherein at least a portion of the array waveguides have a thickness greater than 8 μm.

18. The component of claim 14, wherein at least a portion of the array waveguides have a thickness greater than 10 μm.

19. The component of claim 14, wherein at least a portion of the array waveguides have a thickness greater than 12 μm.

20. The component of claim 14, wherein at least a portion of the array waveguides have a thickness greater than 14 μm.

21. The component of claim 14, wherein at least a portion of the array waveguides have a thickness between 12 and 16 μm.

22. The component of claim 14, wherein at least a portion of the array waveguides include a ridge with a width of between 30% and 100% of the array waveguide thickness.

23. The component of claim 14, wherein at least a portion of the array waveguides include a ridge with a width of between 80% and 100% of the array waveguide thickness.

24. The component of claim 14, wherein at least a portion of the array waveguides include a ridge with a height of 2.5 to 12 μm.

25. The component of claim 14, wherein at least a portion of the array waveguides include a ridge with a height of 3 to 10 μm.

26. A method of forming an optical component, comprising:
obtaining a light transmitting medium positioned adjacent to a base; and
forming a waveguide the light transmitting medium such that the waveguide has a thickness of greater than 12 μm measured from the base.

27. A method of forming an optical component, comprising:
obtaining a light transmitting medium positioned adjacent to a base; and
forming an array waveguide grating in the light transmitting medium, the array waveguide grating including a plurality of array waveguides, at least a portion of the array waveguides having a thickness of greater than 5 μm measured from the base.
